(19) United States
(12) Patent Application Publication
(10) Pub. No.: US 2021/0117434 A1
(43) Pub. Date: Apr. 22, 2021

(54) MACHINE LEARNING OF INSIGHT COMMUNICATION SELECTION TO PROACTIVELY INCREASE USER ENGAGEMENT

(71) Applicant: OJO Labs, Inc., Austin, TX (US)

(72) Inventors: Reed Coke, Austin, TX (US); Kent Czechowski, Austin, TX (US); Jacy Myles Legault, Austin, TX (US); Joshua Howard Levy, Austin, TX (US)

(73) Assignee: OJO Labs, Inc., Austin, TX (US)

(21) Appl. No.: 17/134,476

(22) Filed: Dec. 27, 2020

Related U.S. Application Data
(63) Continuation-in-part of application No. 15/992,851, filed on May 30, 2018.
Application No. 15/992,851 is a continuation of application No. 15/897,885, filed on Feb. 15, 2018, now Pat. No. 10,019,491.
Application No. 15/897,885 is a continuation-in-part of application No. 15/826,151, filed on Nov. 29, 2017, now Pat. No. 10,013,654.
(60) Provisional application No. 62/956,178, filed on Dec. 31, 2019.

(51) Int. Cl. G06F 16/2457; G06F 17/11; G06N 20/00; G06F 40/20; G06F 40/56; G06F 40/186

(52) U.S. Cl. CPC G06F 16/24578; G06F 17/11; G06F 40/186; G06F 40/20; G06F 40/56; G06N 20/00

(57) ABSTRACT

A machine learning of insight communication selection in response to a triggering event in which event data specific to a user is provided to a machine to flexibly and proactively engage with the user through a device, such as any electronic device connected to a data network. In at least one embodiment, an insight selection engine improves insight communication selection to the triggering event by initially filtering a library of insight templates to identify candidate templates that best respond to the event data. In at least one embodiment, the insight selection engine includes an insight ranking module that ranks the identified candidate insight templates to provide an insight communication to the device two proactively engage the user with the system. The insight ranking module learns by receiving feedback, such as a linked recipient action result signal.

### CROSS-REFERENCE TO RELATED APPLICATION

This application is a continuation-in-part of U.S. patent application Ser. No. 15/992,851, which is a continuation of U.S. patent application Ser. No. 15/897,885, which is a continuation-in-part of U.S. patent application Ser. No. 15/826,151 (referred to herein as the “'151 Application”), which are all incorporated by reference in their entireties. This application also claims priority to U.S. Provisional Patent Application No. 62/956,178, which is incorporated by reference in its entirety.

### BACKGROUND OF THE INVENTION

### Field of the Invention

The present invention relates s to supervised learning processing, and more particularly, to a system, method, and computer program product involving machine learning of insight communication selection to proactively increase user engagement with a system.

### Description of the Related Art

Supervised learning is a machine learning process that infers a function for determining an output based on training data, and the function is used to map new input data to an output. A natural language processor (NLP) represents one embodiment of a supervised learning processor. In general, a natural language processor (NLP) includes one or more NLP models to generate a prediction about and a response to a human-understandable, natural language (NL) statement. In at least one embodiment, the NL statement may be a statement, such as a query or command, and the NLP interprets the statement in order to provide a response.

Humans intuitively decide on how to respond to a conversational statement. For example, if a human is asked by an inquiring individual, “How large is the lot at 123 Pecan?” The human intuitively knows the context of the statement relates to the area of a parcel of real estate at a particular address. The human responder then provides an appropriate response. If the human knows the answer, the human responds to the inquirer with the answer. So, if the lot is ½ acre, strictly the answer to the question is “the lot is ½ acre.” However, humans can intuitively enhance the response. For example, the human may know the history and specific details about the inquirer and provide a more insightful response that enhances the answer with information the human could anticipate that the inquirer would want to know or utilize semantics appropriate to the inquirer. For example, if the human knows the inquirer has children and would like a swimming pool, the human in addition to providing the size of the lot, the human may have insights into the inquirer and augment the answer with information with such insights, such as the presence or absence of a pool and state the particular schools nearby. Thus, in response to, “How large is the lot at 123 Pecan?” rather the human may respond, “The lot is rather large at ½ acre, has a pool, and the nearby schools are highly rated.” Additionally, the human can intuitively gauge the acceptability to the inquirer of the response.

However, machines do not have the benefit of human intuition and cannot determine a proper response in the same way as a human. Furthermore, machine responses are often disadvantageously repetitive, ‘mechanical,’ and easily distinguishable from a human response. Additionally, the machine responses are not insightful and do not necessarily engage users with optimally formatted responses.

### SUMMARY OF THE INVENTION

In at least one embodiment, a method of machine learning in the selection of a ranked insight communication to a recipient device associated with a system user is disclosed. In one embodiment, the method includes an electronic, machine learning processing system that operates to initiate selection of a ranked insight communication in response to a triggering event. In at least one embodiment, the machine learning processing system responds to the triggering event by providing event data, where the event data includes user data that is specific to the system user. In at least one embodiment, filter parameters are derived from the event data and a library of insight templates is queried, where the insight templates are associated with respective insight template filtering criteria. In certain embodiments, the query identifies candidate insight templates having template filtering criteria met by the filter parameters. In certain embodiments, the insight templates that meet the insight template filtering criteria are selected as candidate insight templates that, in turn, are received and operated upon by an insight ranking engine to rank the selection of candidate insight templates in accordance with insight ranking criteria. In certain embodiments, a ranked candidate insight template is selected from the ranked insight candidates based on the ranking of the insight candidates to provide an insight communication to the recipient device. In certain embodiments, an insight communication is derived from the selected insight template that responds to the triggering event using the selected candidate insight template. In certain embodiments, the insight communication is provided to the recipient device and feedback is received to allow the insight ranking engine to refine the insight ranking criteria. Other embodiments of this aspect include corresponding computer systems, apparatus, and computer programs recorded on one or more computer storage devices, each configured to perform the actions of the methods.

Another embodiment is directed to an apparatus for machine learning in the selection of a ranked insight communication to a recipient device associated with a system user. In certain embodiments, the apparatus includes one or more data processors; a memory, coupled to the data processors, having code stored therein to cause the one or more data processors to initiate selection of a ranked insight communication in response to a triggering event. In certain embodiments, the code causes the apparatus to respond to the triggering event by providing event data, where the event data includes user data that is specific to the system user. In certain embodiments, the code causes the one or more data processors to derive filter parameters from the event data and query a library of insight templates, where the insight templates are associated with respective insight template filtering criteria. In certain embodiments, the query identifies candidate insight templates having template filtering criteria met by the filter parameters. In certain embodiments, the code causes the one or more data processors to receive a selection of the insight templates that meet the insight template filtering criteria and operate an insight ranking engine to rank the selection of candidate insight templates in accordance with insight ranking criteria. In certain embodiments, the code code causes the one or more data processors to select a ranked candidate insight template that is to be used to provide an insight communication to the recipient device based on the ranking of the candidate insight templates. In certain embodiments, an insight communication is derived from the selected insight template to respond to the triggering event. In certain embodiments, the code operates the one or more processors to receive feedback to the insight ranking engine to refine the insight ranking criteria.

Another embodiment is directed to a non-transitory, computer program product including code stored therein and executable by one or more processors to cause machine learning in the selection of a ranked insight communication to a recipient device associated with a system use, where the code is executable to cause the one or more processors to: initiate selection of a ranked insight communication in response to a triggering event; respond to the triggering event by providing event data, where the event data includes user data that is specific to the system user; derive filter parameters from the event data; query a library of insight templates, where the insight templates are associated with respective insight template filtering criteria, where the query identifies candidate insight templates having template filtering criteria met by the filter parameters; receive a selection of the insight templates that meet the insight template filtering criteria; operate an insight ranking engine to rank the selection of candidate insight templates in accordance with insight ranking criteria; select a ranked candidate insight template that is to be used to provide an insight communication to the recipient device based on the ranking of the candidate insight templates; derive an insight communication that responds to the triggering event using the selected candidate insight template; provide the insight communication to the recipient device; and provide feedback to the insight ranking engine to refine the insight ranking criteria.

Other embodiments include corresponding computer systems, apparatus, and computer programs recorded on one or more computer storage devices, each configured to perform the actions of the methods disclosed herein.

### BRIEF DESCRIPTION OF THE DRAWINGS

The present invention may be better understood, and its numerous objects, features and advantages made apparent to those skilled in the art by referencing the accompanying drawings.

The use of the same reference number throughout the several figures designates a like or similar element.

FIG. 1 depicts an exemplary machine learning system that includes a learning, ranked response selection module.

FIG. 2 depicts one embodiment of the machine learning system that includes a learning, ranked response selection module of FIG. 1.

FIG. 3 depicts an exemplary response ranking and selection process.

FIGS. 4 and 5 depict structured data input.

FIG. 6 depicts a response template data structure and response template library.

FIGS. 7-8 depict selected response template candidates.

FIGS. 9-12 depict exemplary response template ranking parameters and results.

FIG. 13 depicts an exemplary machine learning system that has been augmented with an insight communication system.

FIG. 14 is a flowchart depicting exemplary operations that may be executed to provide an insight communication to a user device using a machine learning system.

FIG. 15 is another flowchart depicting exemplary operations that may be executed to provide an insight communication to a user device using a machine learning system.

FIG. 16 illustrates one manner in which insight types may relate to different insight communications conveying the same message substance but presenting the message using different syntax.

FIG. 17 depicts exemplary insight syntax selections available for a send mortgage handoff mission insight type.

FIG. 18 depicts an exemplary computer system.

FIG. 19 depicts embodiments of a computer implemented natural language processing system.

### DETAILED DESCRIPTION

A machine learning of response selection to structured data input enables a machine to flexibly and responsively actively engage with a response recipient through a device, such as any electronic device connected to a data network. In at least one embodiment, the response selection module improves response selection to the structure data input by initially filtering a library of templates to identify candidate templates that best respond to the input. In at least one embodiment, the response selection module ranks the identified candidate templates to provide the response to the device. The response selection module learns by receiving feedback, such as a linked recipient action result signal. The linked recipient action result signal tracks activity of a recipient that is linked to receipt of a particular response. As a particular response becomes linked more frequently with activity that is considered a success, the probability of selecting the template from which the response was derived increases. To all the response selection module to continue learning, new response templates are introduced to the library of templates. In at least one embodiment, the response selection module selects the new response templates in accordance with a predetermined function to allow the response selection module to gauge success of the new response templates.

In at least one embodiment, the response selection module employs multiple mechanisms to provide ongoing improvement of and learning by the response selection module. Ranking the response templates allows the response selection module to continually learn which response to select and provide to recipients to maximize successful outcomes. Additionally, in at least one embodiment, the response selection module accesses additional data sources that can be processed to provide insights that may be helpful in better engaging the recipient and resulting in improved success rates. Furthermore, insights can yield proactive engagement with a past recipient. Additionally, successful insights can be incorporated into response templates for future use with other recipients. The same learning process then allows the response selection module to learn based on such new insights.

In at least one embodiment, the response selection module uses particular ranking criteria to improve learning by the response selection module of when and which response templates to select for particular recipients. In at least one embodiment, the ranking criteria determines a conversion rate of each candidate template that takes into account multiple factors that influence the ranking process. In at least one embodiment, the conversion rate is defined as recipient activities associated with a template relative to total impressions of the template. In at least one embodiment, the multiple factors that influence the conversion rate include weighting response templates based on (i) activities and measures of closeness that correlate the activity, the recipient, and the provided response and (ii) weighting particular activities where some activities are perceived as more valuable than others. For example, in the context of selling real estate, if the linked recipient action result feedback signal indicates the recipient sends a reply to a response, the response selection module weights the outcome of this activity. If the linked recipient action result feedback signal indicates the recipient schedules a showing of a house, the response selection module weights the outcome of this activity more heavily. Thus, the response selection module provides technical advantages by employing multiple learning mechanisms to enhance the response selection module to learn, modify responses, and improve performance over time to develop machine intuition.

Machine learning of ranked insight communication in response to a triggering event is also disclosed enabling a machine to flexibly and responsively engage in insight communications with the user of a recipient device. As used herein, insight communications include communications sent to the recipient device operated by a system user that are tailored to increase engagement between the system user and, for example, a system operated by a service provider. In certain embodiments, the user may be an individual seeking housing who has engaged an online service to identify housing available to the individual based on search parameters set by the user. Increased engagement between the system user and service provider typically results in greater sales by the service provider. In certain embodiments, the insight communications include questions that may be relevant to the user, but have not been specifically asked by the user. As an example, certain insight communications may include questions regarding update of property listings, financing, procuring an agent, etc. As an extension to this example, certain insight communications may be sent depending on how far the user is in to the housing purchase process. For example, an insight communication asking whether the user is ready to procure financing may be provided when the system determines that the user is close to purchasing a home, or otherwise during any portion of the engagement process in which financing may be advantageous.

In certain embodiments, insight communications are derived through ranked selection of one or more insight templates of a library of insight templates. In certain embodiments, the library of insight templates are queried by an insight engine to identify candidates that meet insight template filtering criterion. In certain embodiments, the query identifies one or more insight communications that the user is eligible to receive based on whether the event data specific to the system user included in the triggering event meets filtering parameters for the insight template. In at least one embodiment, “event data” refers to any data that is provided to the system to generate filter parameters that are compared against the insight filter template criterion. In at least one embodiment, the eligible insight templates are presented to an insight ranking engine, which assigns a rank to each of the eligible insight templates to identify which of the insight templates is more likely to engage the user based on the data associated with the specific user. In certain embodiments, ranking may be based on linked recipient action results for the specific user and/or from a group of users sharing similar characteristics with the specific user. In at least one embodiment, the highest ranking insight template is used to generate the insight communication that is sent to the recipient device.

In certain embodiments, the insight templates of the insight template library may be organized based on insight template types. In at least one embodiment, the insight engine ranks the eligible insight template types to identify the insight template type that is most likely to successfully engage the user. In at least one embodiment, the insight template type includes insight communications having different syntax. As an example, an insight template type may have different language, symbols, hyperlinks, etc. that may be presented to the user as the insight communication. In at least one embodiment, an insight communication ranking engine is operated to rank the selection of insight communications having different syntax. In certain embodiments, the insight communication of the plurality of insight communications having the highest ranked is selected for communication to the recipient device.

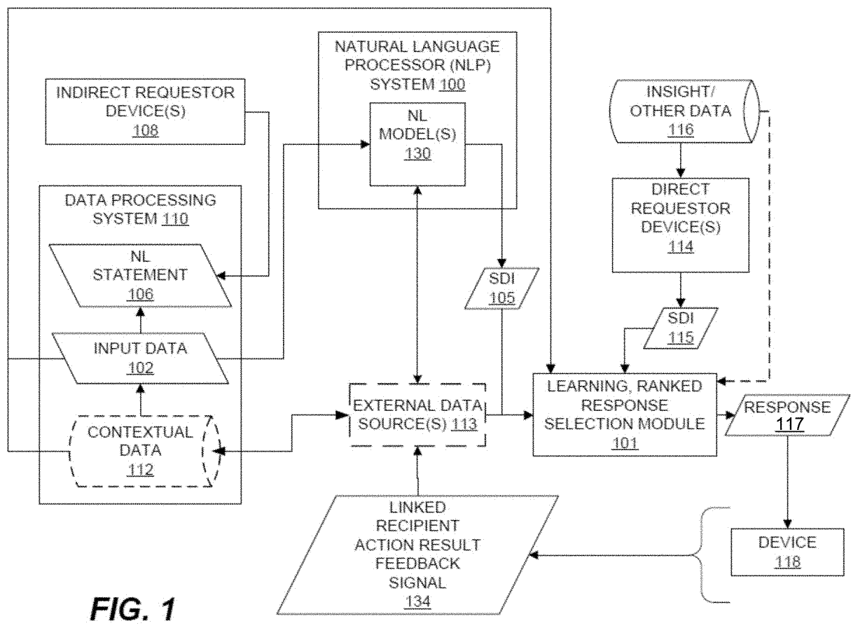

FIG. 1 depicts an exemplary machine learning system 100 that includes a learning, ranked response selection module response selection module 101 that provides responses to structured data input. The response selection module 101 can be implemented as a special purpose hardware machine including as data processing system configured to execute instructions to implement the response selection module 101. The response selection module 101 receives structured data input, utilizes filtering criteria to select candidate response templates from a library of templates, ranks the candidate response templates in accordance with ranking criteria, and sends a response derived from the highest ranked response to device 118. The ranking criteria is adaptive to feedback, such as the linked recipient action result feedback signal 134 or feedback from a human that monitors the structured data input and selected candidate templates. In at least one embodiment, the ranking criteria adapts to the feedback by modifying parameter values of the ranking criteria that improve template selection and, thus, responses to structured data input.

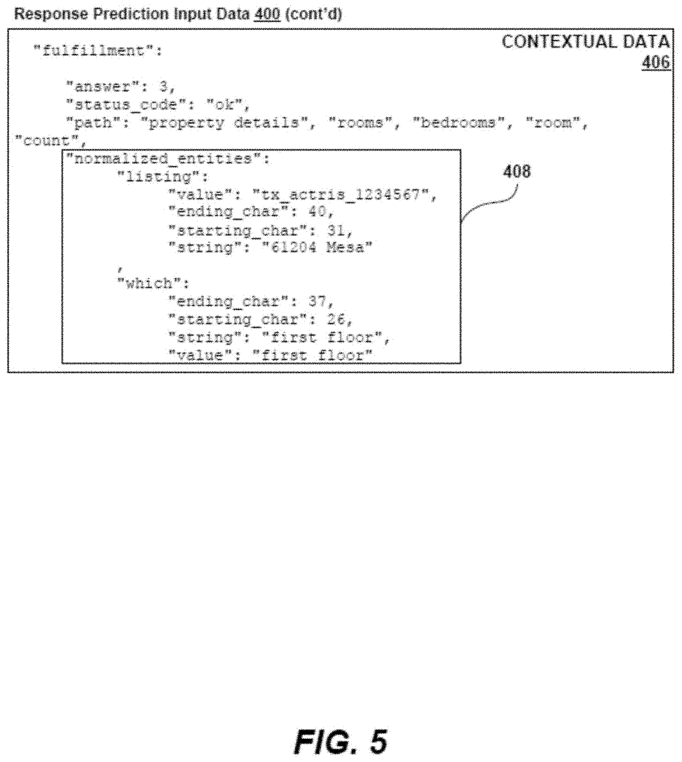

In at least one embodiment, the response selection module 101 can receive structured data input from multiple sources and from multiple types of sources. In at least one embodiment, the structured data input has a natural language processing (NLP) output schema to allow the response selection module 101 to seamlessly interact with natural language processor systems, such as NLP system 100. In at least one embodiment, the NLP output schema refers to a schema utilized by a NLP system such as the schema used in the exemplary response prediction input data 500 (FIG. 5). In at least one embodiment, the NLP system 100 interacts with the data processing system 110 and receives a natural language statement submitted by an indirect requestor device(s) 108 as described as the “requestor device(s)” in the '151 Application. The device(s) 108 is referred to as an “indirect” requestor device in FIG. 1 because the response selection module 101 receives structured data input indirectly from the device(s) 108. The data processing system 110 utilizes the NL statement 106 and contextual data 112 to generate the input data 102 as, for example, described in the '151 Application. In at least one embodiment, contextual data 112 includes conversation state data and user profile data as described in the '151 Application. User profile data represents factual and behavioral information about the user. The NLP system 100 includes natural language (NL) model(s) 130 that generate the structured data input (SDI) 105 as described in the '151 Application. In this embodiment, the structured data input 105 is response prediction input data also as described in the '151 Application.

In at least one embodiment, the response selection module 101 also receives structured data input directly from the direct requestor device(s) 114. In at least one embodiment, the direct requestor device(s) 114 access the insight/other data 116, which includes information that may provide greater insight into users of the indirect requestor device(s) 108. For example, if the insight/other data indicates that one of the users has pets and has searched for houses with particular criteria, the direct requestor device 114 could generate structured data input 115 asking if there are houses that meet the criteria that are within a certain distance from a park and indicate that the response selection module 101 send the response to device 118, which in this instance represents the device 108. In at least one embodiment, the response selection module 101 selects a response in accordance with filter criteria derived from the structured data input 115 and informs the user of a house meeting the user's criteria and enhancing the response with the additional information about a nearby park.

The response selection module 101 can also obtain information from external data source(s) 113 that can include additional information that might be relevant to the user of device 118. In at least one embodiment, the response selection module 101 can utilize the additional information to derive filter criteria to select a response template that may have a higher chance of success in directing the user to a preferred activity.

The linked recipient action result feedback signal 134 represents data that correlates to an activity of a user of the device 118 that is linked to a response 117 provided to the device 118 by the response selection module 101. In at least one embodiment, an external data source(s) 113 receive the feedback signal 134, and, in at least one embodiment, the response selection module 101 receives and stores the feedback signal 134. The source (not shown) of the feedback signal 134 can be any device that can transmit data related to the user of device 118. For example, the source can be an electronic device of a sales person that has information that the user of device 118 performed an activity related to the response 117 and provides this information. The source can be an application that allows the user to communicate the feedback signal 134 directly, such as a direct reply to machine learning system 100 or other action that correlates the response 117 to an activity of the user within a window of time that allows the response selection module 101 to infer that the user's action was linked to the response 117.

The feedback signal 134 enables the response selection module 101 to learn and improve performance by correlating particular actions with a response 117. As subsequently described in more detail, when the response selection module 101 correlates the action and responses, in at least one embodiment, the response selection module 101 adjusts template selection ranking criteria accordingly. By adjusting the ranking criteria, the response selection module 101 can improve ranking and selection of response templates.

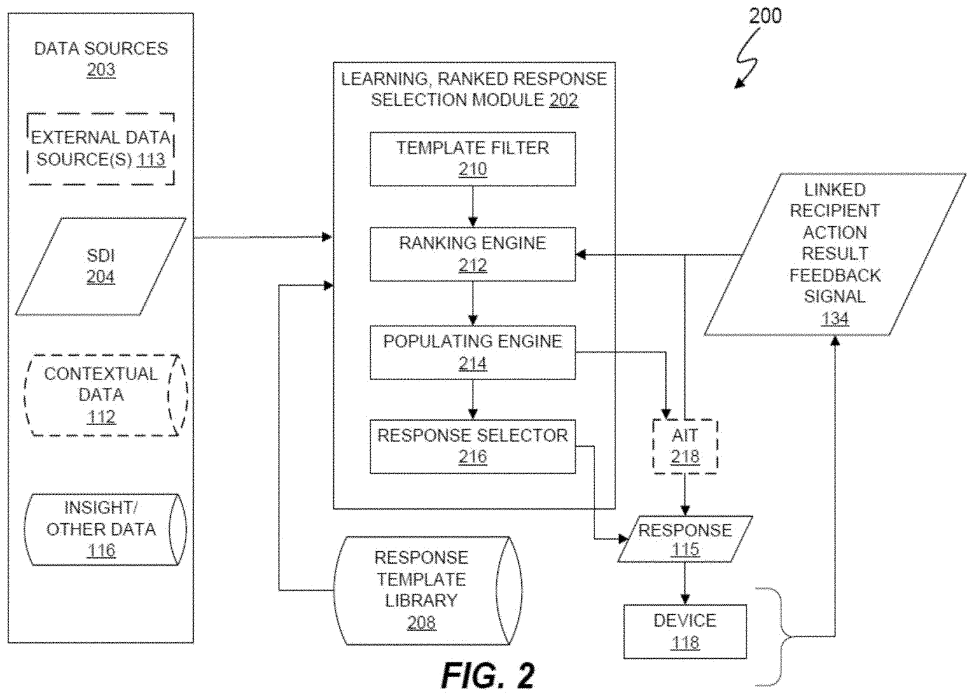

FIG. 2 depicts an exemplary machine learning system 200 that includes learning, ranked response selection module 202, which represents one embodiment of the response selection module 101. As previously discussed in conjunction with the response selection module 101, the response selection module 202 utilizes the data from data sources 203 to select and rank response templates from response template library 208. The structured data input 204 represents structured data input from any source, such as NLP system 100 and device(s) 114.

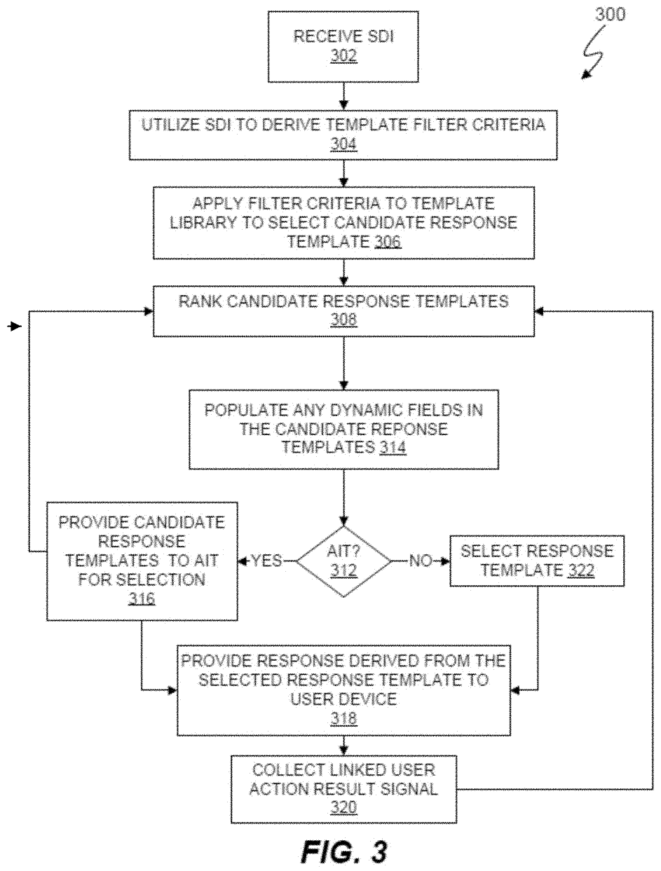

FIG. 3 depicts an exemplary response ranking and selection process 300. In at least one embodiment, the machine learning system 200 operates in accordance with the process 300. Referring to FIGS. 2 and 3, in operation 302 the response selection module 202 receives the structured data input 204, which is constructed in accordance with a natural language processing output schema.

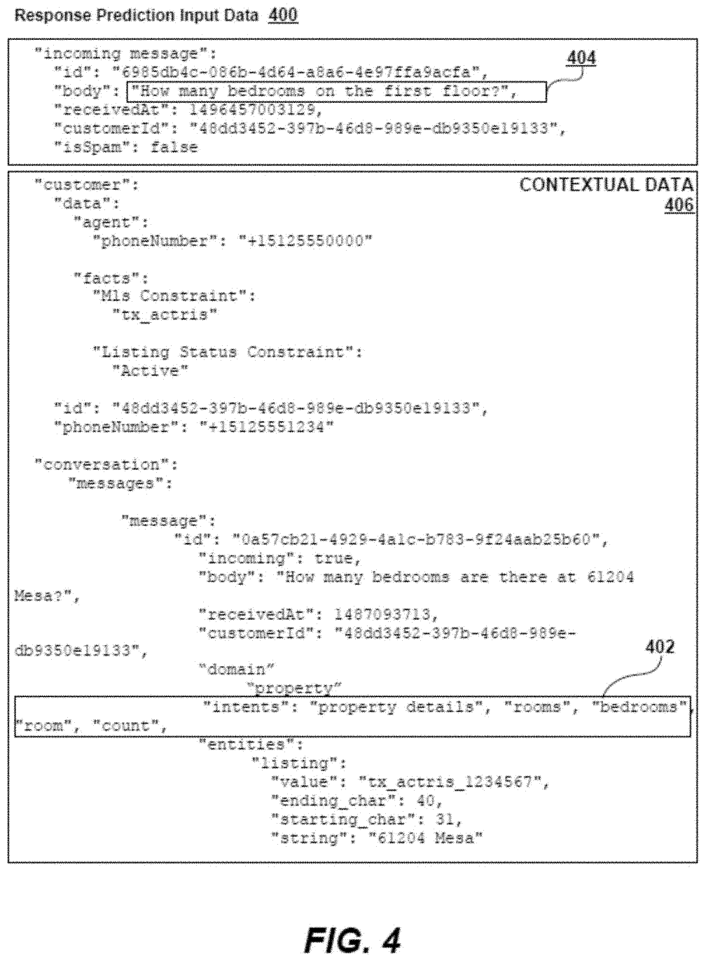

FIGS. 4 and 5 depict exemplary structured data input 400, which is the response prediction input data from the '151 Application. The structured data input 400 includes an incoming message 404 that asks, “How many bedrooms on the first floor?” The contextual data 406 is structured using a natural language processing output schema that includes various parameters such as intents path data 402, i.e. intents path =property details, rooms, bedrooms, room, count. Normalized entities 408 with entity names “listing” and “which,” and associated entity values of “tx actris 1234567” and “first floor,” respectively.

Referring to FIGS. 2-5, operation 302 receives the structured data input 204. The structured data input 204 includes a statement to which the response selection module 202 selects one or more responses. The incoming message 404, “How many bedrooms on the first floor?” represents one example of a statement contained in the structured data input 204. Operation 304 derives template filter criteria utilizing the structured data input 204. The structured data input 204 has a structured natural language processing output schema that allows the response selection module 302 to identify specific parameters within the structured data input 204 from which the response selection module 202 formulates filtering criteria to identify candidate response templates from the response template library 208 that are responsive to the statement. To effectively function as filtering criteria, the response templates 208 include corresponding parameters and values that can be queried against to identify the candidate response templates.

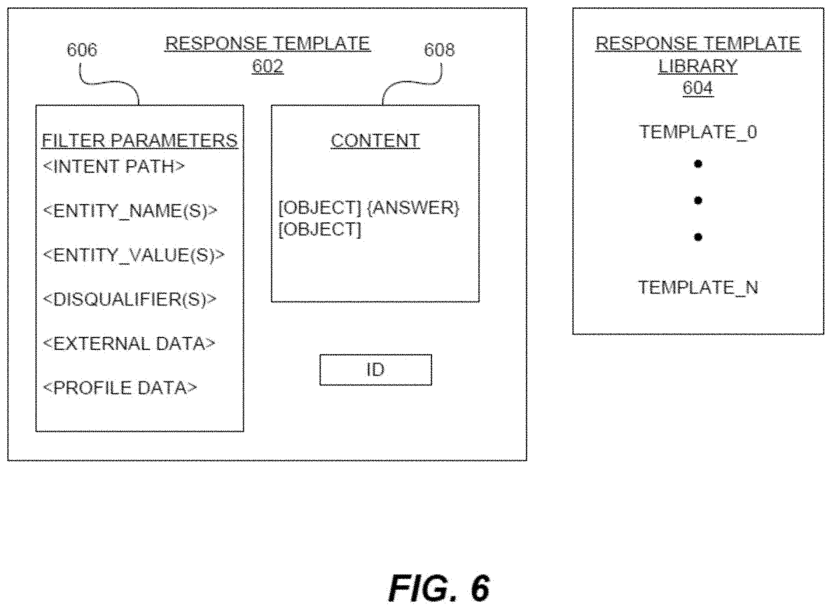

FIG. 6 depicts an exemplary response template data structure 602 and response template library 604. The response template 602 is a data structure that includes filter parameters 606. The depicted filter parameters 606 are illustrative and can be replaced with any filter parameters that allow the response selection module 202 to identify candidate response templates. The filter parameters 602 include <INTENT PATH>, <ENTITY NAME(S)>, and <ENTITY VALUES> that correspond directly to the same type of parameters in data 402 and 408 in the structured data input 204. The filter parameters 606 can include additional parameters and values that may not correspond to parameters in structured data input 204, such as user profile and group profile data in the contextual data 112, insight parameters in the insight/other data 116, and external data in external data source(s) 113. For example, the structured data input 204 may include specific contextual data about the requestor, such as the requestor's age, preferred commute time range, employment location, pets, children, desired spending range, and desired lot, house size, and number of bathrooms in a home buying context. The external data source(s) 113 can include additional information such as details about a home that can be accessed using a multiple listing service (MLS) number, map distances, school districts, school ratings, etc.

The insight/other data 116 can overlap with other data sources but can also include additional information that, for example, may be derived from data from other data sources. Such additional filter parameters are illustratively represented by the <EXTERNAL DATA> and <PROFILE DATA> filter parameters. Accordingly, the filter parameters 602 in the response template can be structured to be responsive to inquiries based on such additional parameters and values. The filter parameters 606 can also include disqualifying data that prevents a response template from being selected. An example disqualifier is if the dynamic content 608 includes mention of an object, such as a pool, and the response should not have such contact because, for example, inclusion of the object in the response 117 could be, for example, misleading.

The response template 602 also includes content data structure 608. The content represents that actual content that can be provided to a device 118. The content can include static and/or dynamic content fields. Dynamic content refers to content that the response selection module 202 populates with data, and the populated data can change depending on, for example, parameters of the structured data input 204. For example, the {ANSWER} field can represent dynamic content such as insertion of a particular address when responding to a real estate related statement. Each [OBJECT] can refer to, for example, static content, such as introductory or concluding phrases. Additionally, the content can include any type of content, such as text, photo, video, and hyperlinks. The response template 602 also includes an identifier (ID) to uniquely identify each response template.

The response template library 604 serves as a storage repository for the response templates N+1 number of response templates, where N is an integer. In at least one embodiment the response template library 604 is stored in a database and is accessible using database queries, such as structured query language (SQL) queries.

Referring to FIGS. 2-6, in at least one embodiment, the response selection module 202 includes a template filter 210 that performs operation 304 to derive the template filter criteria by formulating a query to the response template library 604 to identify response templates having specific parameters and values contained in the structured data input 204. For example, operation 304 utilizes the intent path data 402 of intents path: “property details, rooms, bedrooms, room, count” and the presence of a “listing” entity name to formulate a filter criteria query of select intent_path templates where intent_path=’ property details, rooms, bedrooms, room, count” and required entity_names=“listing.” Operation 306 applies the filter criteria to the template library 604 to identify and select response templates that meet the filter criteria.

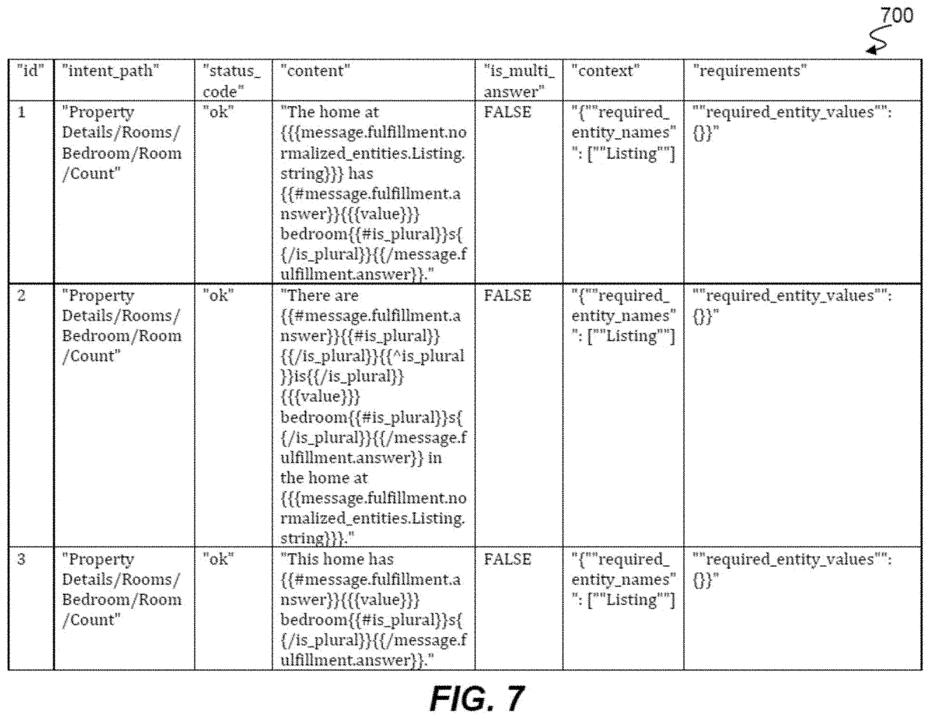

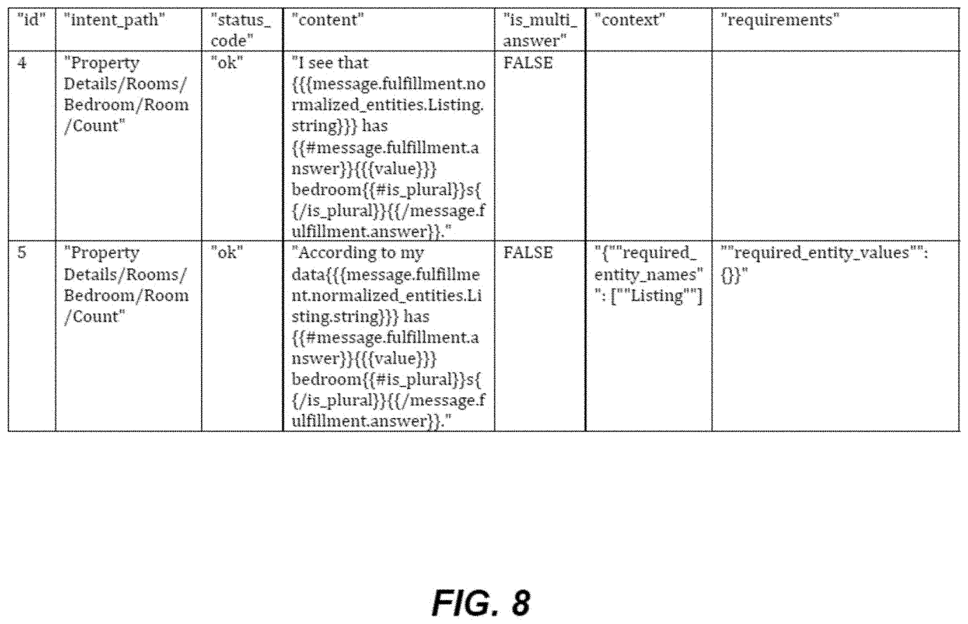

FIGS. 7-8 depict selected candidate response templates having ID's 1-5. Each of the candidate response templates meets the filter criteria for ‘property details, rooms, bedrooms, room, count” and required entity_names=“listing. In at least one embodiment, the candidate response templates have additional qualifiers such as a status code of “ok,” which indicates the response templates are available for use and a qualifier that response templates are not for multi-answers. Each candidate response template 1-5 also indicates that specific entity_values are not required to select the response template. Each response template includes static and dynamic content. For example, response template id=1, has content of ““The home at {{{message.fulfillment.normalized_entities.Listing.string}}} has {{#message.fulfillment.answer}}{{{value}}} bedroom{{#is_plural}}s{{/is_plural}}{{/messagefulfillmentanswer}}.” The bracketed fields enable entry of dynamic content that is populated with values from the data sources 203. For example, from structured data input 400, the content in template 1 is “The home at 61204 Mesa has 3 bedrooms,” the content in template 2 is “There are 3 bedrooms in the home at 61204 Mesa.” The content can also include dynamic insights if available that are populated from data sources 203, such as “The home at 61204 Mesa has 3 bedrooms and a pool,” if an insight into the requestor indicates the requestor was previously interested in properties with a pool.

A ranking engine 212 performs operation 308 and ranks the candidate response templates using ranking criteria. By ranking the candidate templates, the ranking engine 212 allows the response selection module 202 to select the candidate response template with an estimated highest chance of causing the recipient to engage in an activity considered successful, such as replying to the response or taking certain action, like scheduling a showing of a home for purchase. The particular ranking criteria is a matter of design choice. Exemplary ranking criteria is set forth below:
for each candidate response template, determining the conversion rate in accordance with equation [1]:

$$Conversion Rate = \frac{Success Count}{Attempt Count} \\ Success Count = {\sum }_{a} ( {SC}_{User} + {SC}_{Group} + {SC}_{All} ) \\ Attempt Count = {\sum }_{a} ( {I}_{User} + {I}_{Group} + {I}_{All} ) \\ {SC}_{User} = {w}_{a} {w}_{U} ‖ {conversions}_{a , U} ( ∅ ) ‖ \\ {SC}_{Group} = {w}_{a} {w}_{G} {\sum }_{k ∈ x} ‖ {conversions}_{a , k} ( ∅ ) ‖ \\ {SC}_{All} = {w}_{a} {w}_{A} ‖ {conversions}_{a , A} ( ∅ ) ‖ \\ Attempt Count = {\sum }_{a} ( {I}_{User} + {I}_{Group} + {I}_{All} ) \\ {I}_{User} = {w}_{a} {w}_{U} ‖ {impressions}_{a , U} ( ∅ ) ‖ \\ {I}_{Group} = {w}_{a} {w}_{G} {\sum }_{k ∈ x} ‖ {impression}_{a , k} ( ∅ ) ‖ \\ {I}_{All} = {w}_{a} {w}_{A} ‖ {impressions}_{a , A} ( ∅ ) ‖ \qquad [ 1 ]$$

wherein:
wₐ is an activity weight;
w_{U} is a user weight of a user U associated with the structured data input, w_{G} is a group weight of a group G that includes the user and is a subset of all users of the supervised learning processing system, and WA is a weight for all users A of the supervised learning processing system;
conversion is a conversion associated with the response template for an activity a by a user the user U, the group G, or all users A; and
impression is an impression associated with the response template for an activity a by a user the user U, the group G, or all users A.

In summary, the foregoing ranking criteria determines a conversion rate that is based on conversions and impressions by a user, a group with similar attributes as the user, and all users. Successes for the user are more indicative of future success than successes by the group and all users, and successes for the group are more indicative of future success than successes by the all users. Furthermore, different activities are considered more valuable than others as previously described. By determining the weighted conversions and activities relative to the total number of impressions, the ranking engine 212 determines a conversion rate that provides a measure of performance for each candidate response template. The ranking engine 212 revises the number of impressions and from feedback signal 134 adjusts the conversion data. Furthermore, the weights can be adjusted to further enhance the learning of the ranking engine 212.

In at least one embodiment, the conversion rate is a function of the success values and the attempt values, i.e. conversion rate=f(success, attempt), and not strictly (success/attempt). For example, the conversion rate function can incorporate distributions, such as beta distributions parameterized by success and attempt values, of conversion rates and ranking of the candidate response template can be based on a random sampling of the conversion rate values in the distribution. Utilizing this ‘distribution’ based conversion rate function allows a probability of assigning a higher conversion rate based ranking to candidate response templates that do not have the strictly highest (success/attempt) value. In at least one embodiment, the particular distributions are mathematically shaped to provide a probably frequency of ranking a particular candidate response template with the highest conversion rate. By allowing the ranking engine 212 to distribute the highest conversion rate ranking among candidate response templates, the response selection module 202 learns the effectiveness of different response templates. Additionally, the response selection module 202 can insert new response templates into the collection of candidate response templates to allow the response selection module 202 to learn about the success of the experimental response templates. When adding new response templates that do not have observed conversion and impression values, the conversion rate function can be modified to ensure any number of highest conversion rate values for each candidate response template by, for example, inserting an override factor that forces a high conversion rate of the new candidate response template. The override factor can be, for example, a weight selected from a distribution of weights or a random number that ensures selection of the new candidate response template at some probabilistic frequency. In at least one embodiment, the override factor is determined by an epsilon-greedy function that forces occasional highest ranking and selection of the new candidate response template.

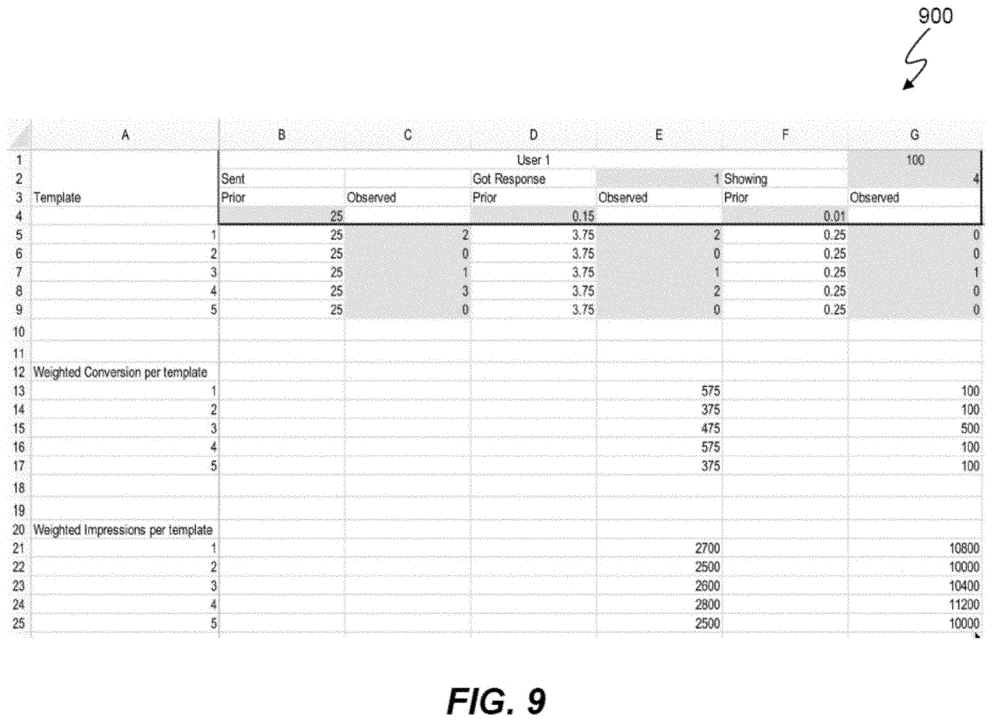

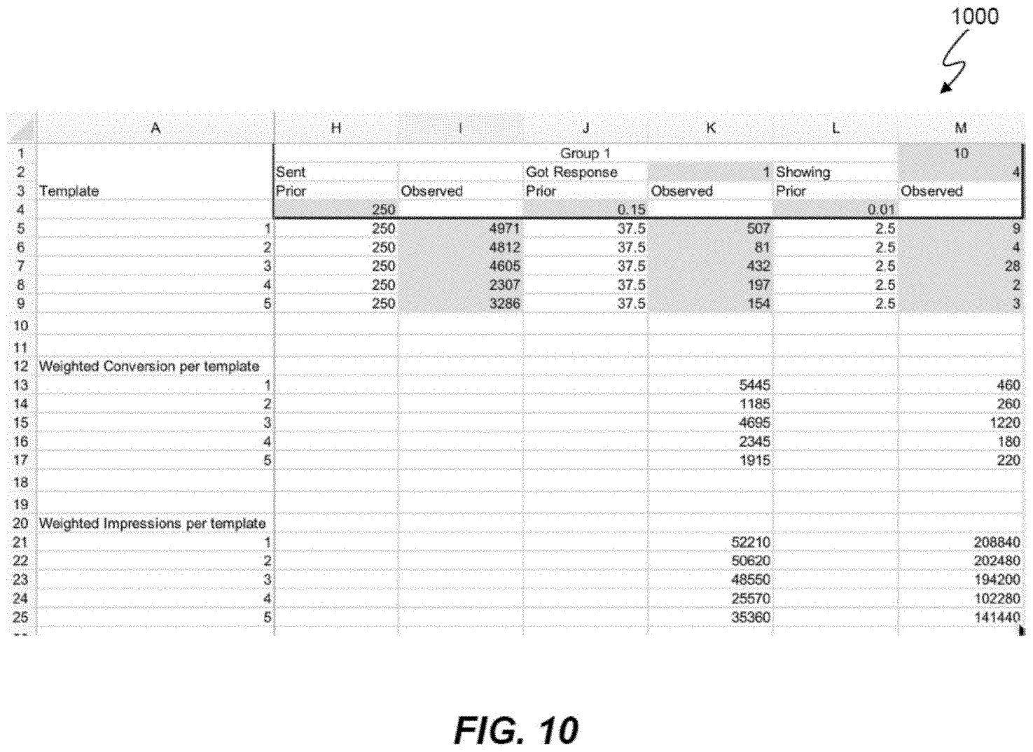

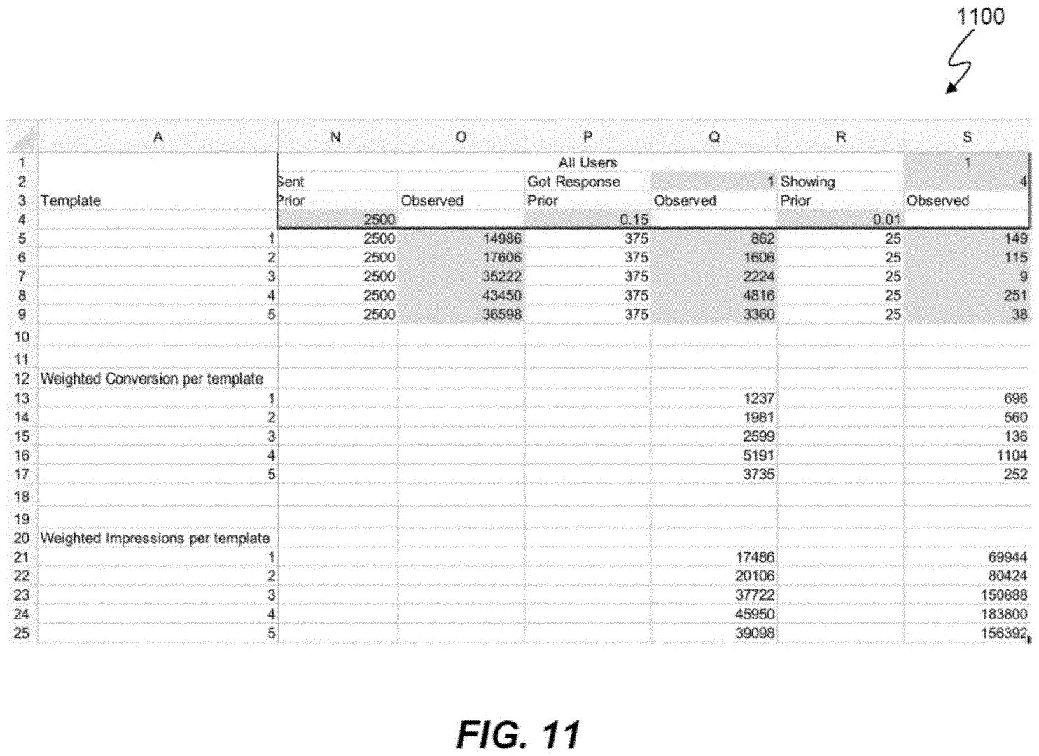

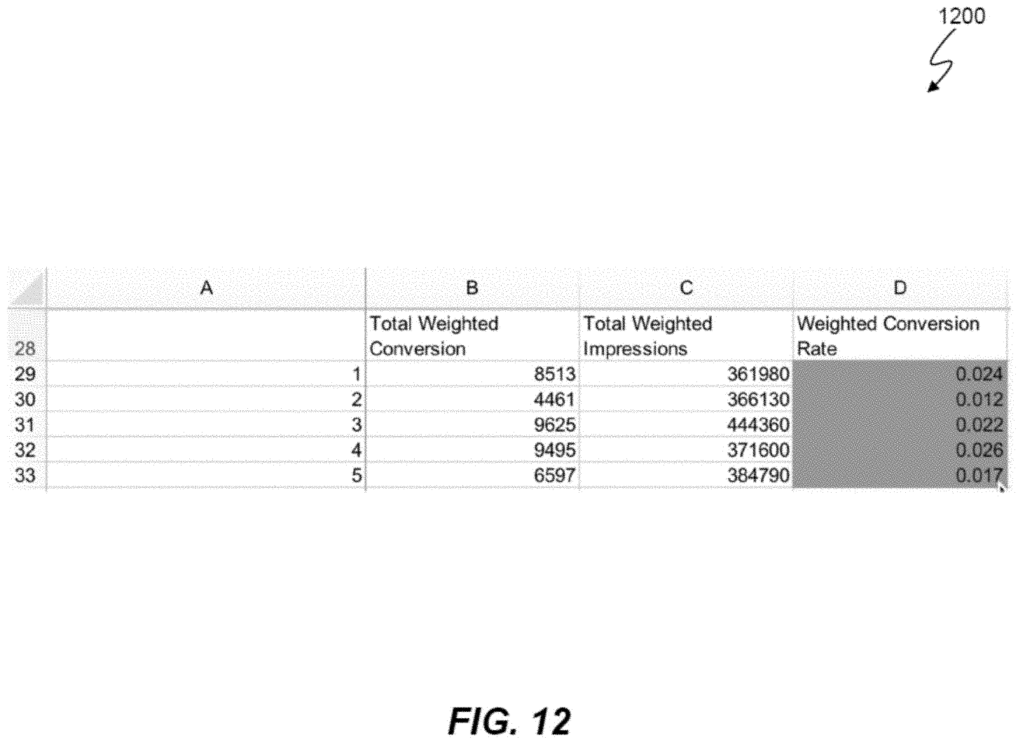

FIGS. 9-12 depict exemplary response template ranking parameters and results. Cells G1, M1, and S1 are values of respective weights w_{U}, w_{G}, and w_{A}. Each weight from the user to group to all is an order of magnitude larger, which represents the relative importance of the conversion feedback. Cells E2, K2, and Q2 represent weight wₐ=1 for a user activity of “Got Response,” which is receiving a reply to the response derived from the particular response template. Cells G2, M2, and S2 represent weight wₐ=4 for a user activity of “Showing” of a property because showing is more valuable than receiving a response. The ranking results include “Prior” and “Observed” results. “Prior” is inserted as a value that represents estimated performance to initialize the ranking data so that the conversion rates are more meaningful. “Prior” and “Observed” values are added together for purposes of values in Equation [1]. The weighted conversions, weighted impressions, and overall conversion rates are computed in accordance with Equation [1].

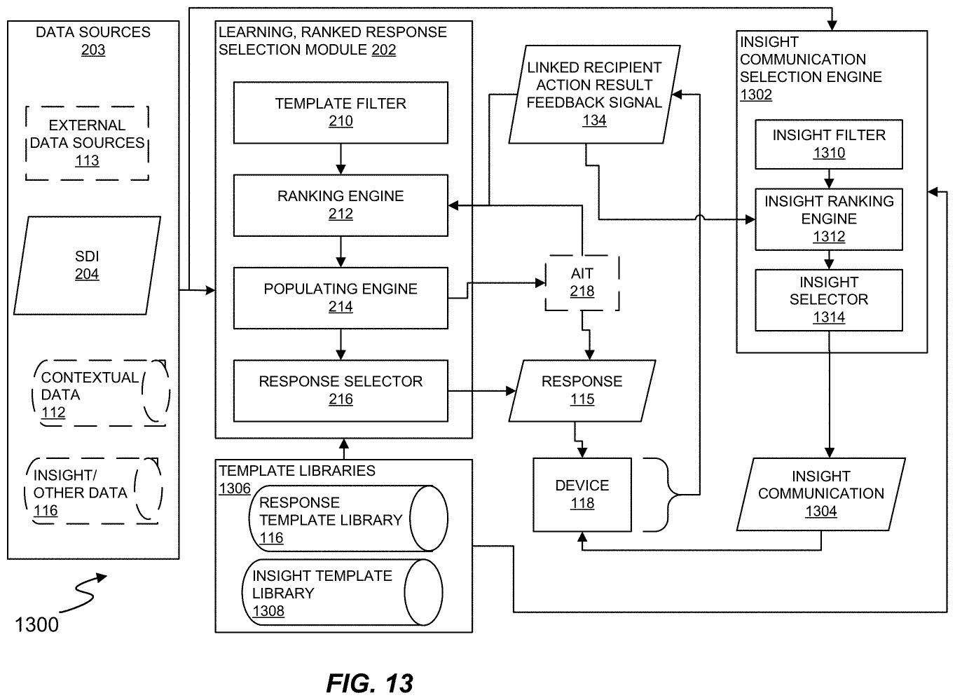

FIG. 13 depicts an exemplary machine learning system 1300 that has been augmented with an insight communication system. In certain embodiments, the insight communication system may augment a response machine learning system, such as the exemplary response machine learning system shown in FIG. 2. The example shown in FIG. 13 includes several elements that are common to the system in FIG. 2 and use the same reference numbers.

Certain embodiments of the machine learning system 1300 include components used to rank and communicate insights to the user device 118. In certain embodiments, operations of the insight communication system may be initiated by a triggering event. In certain embodiments, the triggering event may be time-based and use various lapsed time indicators to initiate insight communications with the user device 118. For example, a triggering event may be generated if it is determined that the user as not logged into the system 1300 over a predetermined period of time. As an extension of this example, the machine learning system 1300 may push an insight communication to the user device 118 if it has been X number of days since the last time the user logged into the system. As a further extension of this example, the machine learning system 1300 may push an insight communication that asks the user if there are any changes that the user would like to make to their property search criteria. Other types of insight communications may be pushed to the user device 118 using time-based criteria, the foregoing merely being exemplary.

In certain embodiments, operations of the insight communication system 1300 may be initiated when a user logged into the system using the user device 118. In certain embodiments, insight communications may be initiated when the user requests a response to a particular question as indicated in the SDI 204. As an example, if the user requests information on a specific property, the insight communication system 1300 may provide an insight communication asking the user whether the user would like to see other properties within the same locality as the specific property. In certain embodiments, the insight communications provided to the device 118 may include questions that are relevant to engaging the user but are not directly asked by the user.

In certain embodiments, the machine learning system 1300 responds to the triggering event by providing event data to an insight communication selection engine 1302. In at least one embodiment, the event data may be provided from one or more of the data sources 203. In at least one embodiment, the event data includes user data that is specific to the system user. For example, the event data may include user profile information such as age, sex, address, current user location (i.e., GPS coordinates of the user device 118 while the user is logged into the system), etc. It will be recognized based on the teachings of the present disclosure, that the event data provided to the insight communication selection engine 1302 may include any data that may be useful to generate an insight communication that is likely to increase engagement between the user in the system.

In certain embodiments, the insight communication selection engine 1302 includes an insight filter module 1310, an insight ranking engine 1312, and an insight selector module 1314. In certain embodiments, the insight filter module 1310 operates to determine which insight template(s) of insight template library 1308 are eligible for deriving an insight communication for the user. In certain embodiments, the insight filter module 1310 derives filter parameters from the event data obtained from the data sources 203. In certain embodiments, the insight filter module 1310 queries the library of insight templates 1308 using insight template filtering criterion. In certain embodiments, a user is only eligible to receive an insight template when the filter parameters of the event data match the insight template filter criterion of the insight template.

Template filtering criterion may be incorporated into 1300 in a variety of manners. In certain embodiments, the insight template filtering criterion are embedded in the insight template objects of the insight template library 1308. As an example, an insight template object may itself include insight template filtering criterion as part of the object definition of the insight template object. In certain embodiments, the insight filter module 1310 queries the insight template filtering criterion of the insight template objects using the filter parameters derived from the event data. In certain embodiments, if the filter parameters meet the filtering criterion of an insight template object, the insight template object is considered as an insight template candidate that may be used to derive an insight communication sent to the user device 118.

Additionally, or on the alternative, the insight template filtering criterion may be included in pointer objects that are linked to the insight template objects. As an example, individual filter criterion objects, separate from the insight templates, may be generated for comparison with the filter parameters derived from the event data. In certain embodiments, the criterion objects are configured to point to insight templates that a user is eligible to receive if the filter parameters of the event data match the insight template filtering criterion of the criterion object. If a match with a criterion object is found, the user is eligible to receive communications derived from one or more insight templates to which the criterion object points, and the insight template to which the criterion object points is considered an insight template candidate that may be used to derive the insight communications sent to user device 118.

In certain embodiments, insight templates that the user is eligible to receive are selected by the insight filter 1310 and passed to the insight ranking engine 1312. In certain embodiments, the insight ranking engine is configured to rank the selection of candidate insight templates in accordance with insight ranking criteria. In certain embodiments, the insight ranking engine 1312 is configured to receive the linked recipient action result feedback signal 134. The linked recipient action result feedback signal 134 represents data that correlates to an activity of a user of the device 118 that is linked to an insight communication 1304 provided to the device 118 by the insight communication selection engine 1302. In at least one embodiment, an external data source(s) 113 receive the feedback signal 134, and, in at least one embodiment, the insight ranking engine 1312 receives and stores the feedback signal 134. As described above, the source (not shown) of the feedback signal 134 can be any device that can transmit data related to the operation of device 118 by a user. For example, the source can be an electronic device of an agent or a financial institution that has information that the user of device 118 performed an activity related to the insight communication 1304. Additionally, or on the alternative, the source can be an application that allows the user to communicate the feedback signal 134 directly, such as a direct reply to machine learning system 1300 or other action that correlates the insight communication 1304 to an activity of the user within a window of time that allows the insight ranking engine 1312 to infer that the user's action was linked to the insight communication 1304.

The feedback signal 134 enables the insight communication selection engine 1302 to learn and improve performance by correlating particular actions with an insight communication 1304. In certain embodiments, the insight communication selection engine 1302 correlates the user's responses to insight communications and adjusts insight template selection ranking criteria accordingly. By adjusting the insight template ranking criteria, the insight communication selection engine 1302 can improve ranking and selection of insight templates to increase the likelihood of engagement between the user and the system.

The insight ranking engine 1312 may rank candidate insight templates in a manner similar to the manner in which the ranking engine 212 ranks the candidate response templates using ranking criteria. By ranking the candidate insight templates, the insight ranking engine 1312 allows the insight communication selection engine 1302 to select the candidate insight template with an estimated highest chance of causing the recipient to engage in an activity considered successful, such as replying to the insight communication or taking certain action, like scheduling a showing of a home for purchase, engaging an agent, engaging a financial institution, etc. The particular ranking criteria is a matter of design choice. Exemplary ranking criteria is set forth below:
for each candidate insight template, determining the conversion rate in accordance with equation [2]:

$$Conversion Rate = \frac{Success Count}{Attempt Count} \\ Success Count = {\sum }_{a} ( {SC}_{User} + {SC}_{Group} + {SC}_{All} ) \\ Attempt Count = {\sum }_{a} ( {I}_{User} + {I}_{Group} + {I}_{All} ) \\ {SC}_{User} = {w}_{a} {w}_{U} ‖ {conversions}_{a , U} ( ∅ ) ‖ \\ {SC}_{Group} = {w}_{a} {w}_{G} {\sum }_{k ∈ x} ‖ {conversions}_{a , k} ( ∅ ) ‖ \\ {SC}_{All} = {w}_{a} {w}_{A} ‖ {conversions}_{a , A} ( ∅ ) ‖ \\ Attempt Count = {\sum }_{a} ( {I}_{User} + {I}_{Group} + {I}_{All} ) \\ {I}_{User} = {w}_{a} {w}_{U} ‖ {impressions}_{a , U} ( ∅ ) ‖ \\ {I}_{Group} = {w}_{a} {w}_{G} {\sum }_{k ∈ x} ‖ {impression}_{a , k} ( ∅ ) ‖ \\ {I}_{All} = {w}_{a} {w}_{A} ‖ {impressions}_{a , A} ( ∅ ) ‖ \qquad [ 1 ]$$

wherein:
wₐ is an activity weight;
w_{U} is a user weight of a user Uto which the insight communication 1305 is sent, w_{G} is a group weight of a group G that includes the user and is a subset of all users of the supervised learning processing system 1300, and w_{A} is a weight for all users A of the supervised learning processing system;
conversion is a conversion associated with the insight templates for an activity a by the user U, the group G, or all users A; and
impression is an impression associated with the insight template for an activity a by the user U, the group G, or all users A.

As described above, the foregoing insight template ranking criteria determines a conversion rate that is based on conversions and impressions by a user, a group with similar attributes as the user, and all users. Successes for the user are more indicative of future success than successes by the group and all users, and successes for the group are more indicative of future success than successes by the all users. Furthermore, different activities are considered more valuable than others. By determining the weighted conversions and activities relative to the total number of impressions, the insight ranking engine 1312 determines a conversion rate that provides a measure of performance for each candidate response template. The insight ranking engine 1312 revises the number of impressions and from feedback signal 134 adjusts the conversion data. Furthermore, the weights can be adjusted to further enhance the learning of the insight ranking engine 1312.

In at least one embodiment, the conversion rate is a function of the success values and the attempt values, i.e. conversion rate=f(success, attempt), and not strictly (success/attempt). For example, the conversion rate function can incorporate distributions, such as beta distributions parameterized by success and attempt values, of conversion rates and ranking of the candidate response template can be based on a random sampling of the conversion rate values in the distribution. Utilizing this ‘distribution’ based conversion rate function allows a probability of assigning a higher conversion rate based ranking to candidate insight templates that do not have the strictly highest (success/attempt) value. In at least one embodiment, the particular distributions are mathematically shaped to provide a probable frequency of ranking a particular candidate insight template with the highest conversion rate. By allowing the insight ranking engine 1312 to distribute the highest conversion rate ranking among candidate insight templates, the insight communication selection engine 1302 learns the effectiveness of different insight templates. Additionally, the insight communication selection engine 1302 can insert new response templates into the collection of candidate insight templates to allow the insight communication selection engine 1302 to learn about the success of the experimental insight templates. When adding new insight templates that do not have observed conversion and impression values, the conversion rate function can be modified to ensure any number of highest conversion rate values for each candidate insight template by, for example, inserting an override factor that forces a high conversion rate of the new candidate insight template. The override factor can be, for example, a weight selected from a distribution of weights or a random number that ensures selection of the new candidate insight template at some probabilistic frequency. In at least one embodiment, the override factor is determined by an epsilon-greedy function that forces occasional highest ranking and selection of the new candidate insight template.

In at least one embodiment, the insight ranking engine 1312 provides the ranked candidate insight templates to the insight selector 1314. The insight template selector 1314 is configured to generate the insight communication 1304 using the highest ranked candidate insight template. In certain embodiments, the insight template selector 1314 is configured to generate the insight communication 1304 based on a statistical ranking of the highest ranked candidate insight templates. As an example, the insight template selector 1314 may be configured to select a candidate insight template based on whether the ranking of the candidate insight template falls within a certain percentile of the overall candidate insight template rankings, as opposed to limiting selection to only the candidate insight template having the highest rank. In certain embodiments, the insight selector 1314 may be configured to randomly select a candidate insight template from a set of high ranking candidate insight templates. So long as the insight selector 1314 is configured to limit its selection to high ranking candidate insight templates for deriving of the insight communication 1304, the resulting insight communication 1304 generally has a greater likelihood of engaging the user than insight communications derived from low ranking insight templates.

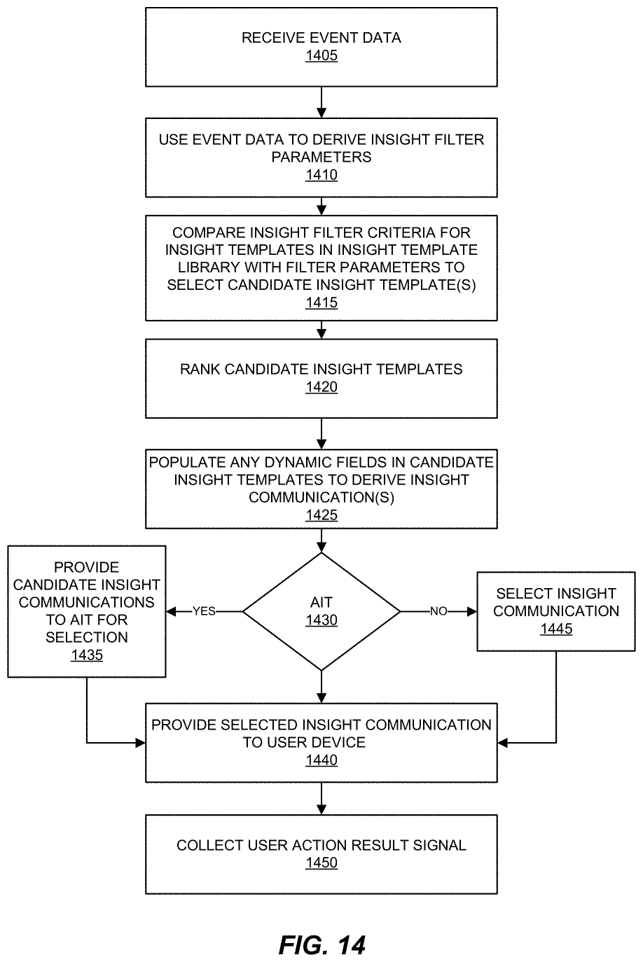

FIG. 14 is a flowchart depicting exemplary operations that may be executed to provide an insight communication to a user device using, for example, the machine learning system 1300. In certain embodiments, the machine learning system 1300 reacts to the occurrence of a trigger. In certain embodiments, the machine learning system 1300 receives event data relating to the trigger at operation 1410 and uses the event data to derive insight filter parameters at operation 1410. In certain embodiments, the event data includes data that is specific to the user associated with the triggering event. As an example, the event data may include user profile data as well as other data described above. At operation 1415, the insight filter criteria of the insight templates in the insight library are compared with the filter parameters derived from the event data to arrive at a set of candidate insight templates. As an example, an insight template may be considered as a candidate insight template when the filter parameters meet the insight filter criteria for an insight template.

In certain embodiments, the comparisons between the filter parameters and the filter criteria identify which insight templates are eligible for generating an insight communication to the user. In certain embodiments, the comparison may be used to prevent sending the same insight communication to the same user more than once. In certain embodiments, comparison may be used to send an insight communication to the user that is similar, but not identical, to an insight communication previously sent to the user. In certain embodiments, the similar insight communication may convey the same general message as the prior insight communication, but present the insight communication in a different manner, such as using different syntax so as not to seem repetitive.

In certain embodiments, the comparisons between the filter parameters and the filter criteria identify insight templates that the user is eligible to receive based on the degree to which the user has engaged the system. As an example, the user may be eligible to receive a welcoming insight communication once the user sets up an account on the system, but ineligible to receive another welcoming insight communication after the account has been set up. As another example, once the user has set up an account, the user may be eligible to receive an insight communication asking the user if the user would like to set up search criteria for a housing search. As another example, once the user has set up housing search, the user may be eligible to receive an insight communication asking whether the user wishes to change and/or update the search parameters. As an example, a user may be eligible to receive an insight communication relating to a change and/or update if the user has consistently viewed houses having common characteristics thereby indicating that the user is interested in property having this common characteristic. As another example, a user may be eligible to receive an insight communication asking whether the user is ready to procure financing when the system determines that the user is close to purchasing a home, or otherwise during any portion of the engagement process in which financing may be advantageous. It will be recognized, based on the present disclosure, that numerous insight filter criteria may be used to select specific templates that the user is eligible to receive, the foregoing being merely non-limiting examples.

In certain embodiments, the system may determine that the user is eligible to receive different insight communications derived from different candidate insight templates. In certain embodiments, the candidate insight templates are ranked at operation 1420. Candidate insight template ranking may be accomplished in various manners, including those discussed herein. In certain embodiments, the candidate insight templates may include dynamic fields, which are populated by the system at operation 1425. In certain embodiments utilizing an AIT, a decision is made at operation 1430 as to whether the insight communications derived from the eligible candidate insight templates are provided to the AIT at operation 1435 or automatically selected by the system at operation 1445.

In certain embodiments, the automatic selection of the insight communication that is to be sent to the user is based on the rank of the insight communication. In certain embodiments, the highest ranking insight communication is selected at operation 1445 for transmission. In certain embodiments, the insight communication may be automatically, randomly selected from insight communications within a predetermined range of percentile ranking. In certain embodiments, the insight communication may be automatically selected based on the frequency at which the insight communication has been sent to all users of the system. As an example, if a user is eligible to receive a given insight communication, but that given insight communication has been used frequently by the system, a less frequently used insight communication may be selected at operation 1445. Selecting and/or eliminating an insight communication based on the overall frequency of use of the same insight communication may reduce the appearance of robotic redundancy to multiple users who know one another. It will be recognized, based on the teachings of the present disclosure, that there are various manners of selecting which insight communication is to be selected at operation 1445.

In certain embodiments, the selected insight communication is provided to the user device at operation 1440. Any user action, including, for example, the failure of a user to act on the insight communication may be collected at operation 1450. In certain embodiments, actions and/or inactions to the insight communication may be provided, for example, to the linked recipient action result feedback signal module 134, and used by the insight ranking engine 1312 during subsequent ranking of the insight templates of the insight template library 1308.

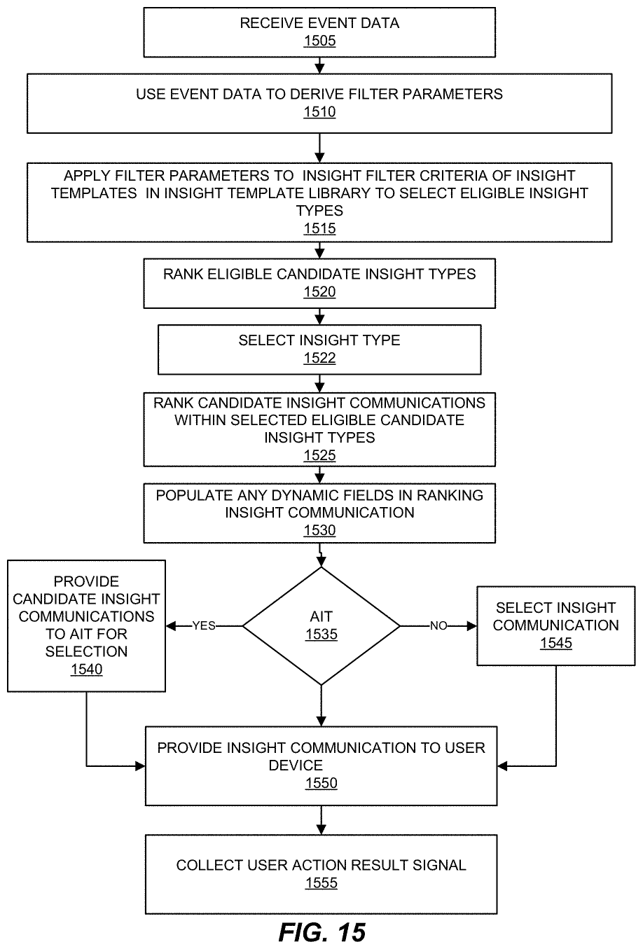

FIG. 15 is another flowchart depicting exemplary operations that may be executed to provide an insight communication to a user device using, for example, the machine learning system 1300. In the example in certain embodiments, the machine learning system 1300 reacts to the occurrence of a trigger. In certain embodiments, the machine learning system 1300 receives event data relating to the trigger at operation 1505 and uses the event data to derive insight filter parameters at operation 1510. In certain embodiments, the event data includes data that is specific to the user associated with the triggering event.

In this example, the insight templates can be assigned an insight template type. In certain embodiments, multiple insight templates may be assigned to the same insight template type. As an example, a financing insight type may be assigned to a set of insight templates relating to financing, while a broker engagement insight type may be assigned to a different set of insight templates. In certain embodiments, insight templates having the same insight type are intended to convey substantially the same message, but do so in a different manner, such as using different syntax, graphics, etc. In such embodiments, the filter parameters derived at operation 1510 are applied to the insight filter criteria of the insight templates to identify eligible insight types at operation 1515. Once the eligible insight types have been identified as candidate insight types, certain embodiments rank the eligible candidate insight types at operation 1520. In certain embodiments, the insight type from which the insight communication is to be derived is selected at operation 1522. In certain embodiments, the insight type selected at operation 1522 corresponds to the highest ranking insight type.

In certain embodiments, the granularity of the ranking is further enhanced by ranking the selected insight type based on the manner in which the substance of the insight message is to be communicated to the user. In certain embodiments, an insight type may be expressed to the user in different manners. In certain embodiments, the efficacy of the different manners in which the substance of the insight message is communicated to the user may be tracked by the insight ranking engine 1312. To this end, certain embodiments rank the candidate insight communications within the selected eligible candidate insight types at operation 1525 and populate any dynamic fields at operation 1530 before determining at operation 1535 whether the insight communication is to be provided to an AIT at operation 1540 or automatically selected at operation 1545.

In certain embodiments, selection of the insight communication, the automatic selection of the insight communication that is to be sent to the user is based on the rank of the insight communication. In certain embodiments, the highest ranking insight communication is selected at operation 1545 for transmission. In certain embodiments, the insight communication may be automatically, randomly selected from insight communications within a predetermined range of percentile ranking. In certain embodiments, the insight communication may be automatically selected based on the frequency at which the insight communication has been sent to all users of the system. As an example, if a user is eligible to receive a given insight communication, but that given insight communication has been used frequently by the system, a less frequently used insight communication may be selected at operation 1545. Selecting and/or eliminating an insight communication based on the overall frequency of use of the same insight communication may reduce the appearance of robotic redundancy to multiple users who know one another. It will be recognized, based on the teachings of the present disclosure, that there are various manners of selecting which insight communication is to be selected at operation 1545.

In certain embodiments, the selected insight communication is provided to the user device at operation 1550. Any user action, including, for example, the failure of a user to act on the insight communication may be collected at operation 1555. In certain embodiments, actions and/or inactions to the insight communication may be provided, for example, to the linked recipient action result feedback signal module 134, and used by the insight ranking engine 1312 during subsequent ranking of the insight templates of the insight template library 1308.

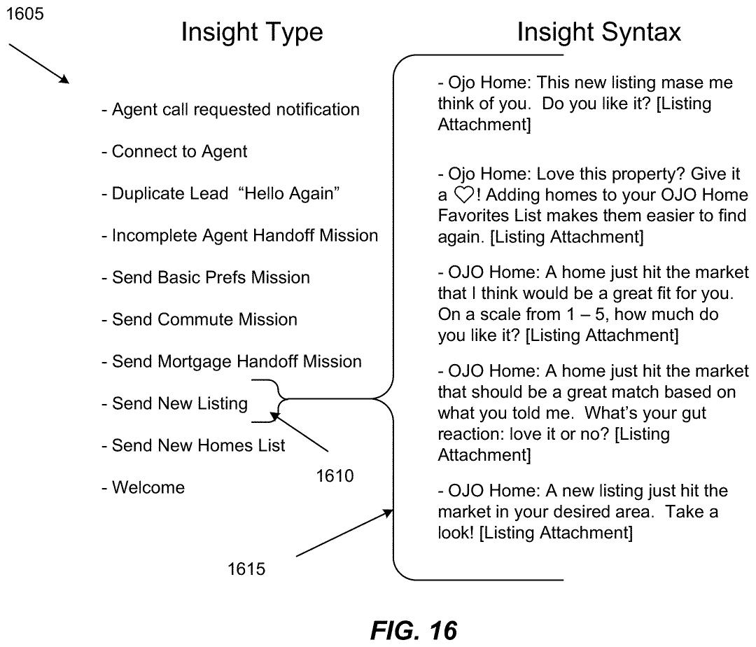

FIG. 16 illustrates one manner in which insight types may relate to different insight communications conveying the same message substance but presenting the message using, for example, different syntax. In this example, the system uses multiple insight types as shown at 1605.

In the example shown in FIG. 16, the insight type “Send New Listing” 1610 may be conveyed to the user with different insight syntax number 1615. In certain embodiments, if the system selects the send new listing insight type as the type of insight that is to be sent to the user, the system may select the specific insight communication that is to be sent to the user from any of the available messages having different insight syntax 1615. In certain embodiments, the insight communication syntax may be ranked as part of the insight templates ranking process such that each of the insight communications 1615 are included in different insight templates. In certain embodiments, the insight syntax 1615 for the insight template type may be included in a single insight template object, where the ranking of the insight syntax is set forth in the insight template object. It will be recognized, in view of the teachings of the present disclosure, that various manners of selecting the insight syntax that is to be used for a given insight type may be employed.

In the specific examples of the insight syntax 1615 shown in FIG. 16, the user is asked to respond to a new listing in various manners. In certain embodiments, the insight syntax may include a link to a corresponding listing attachment for a new listing that may be of interest to the user.

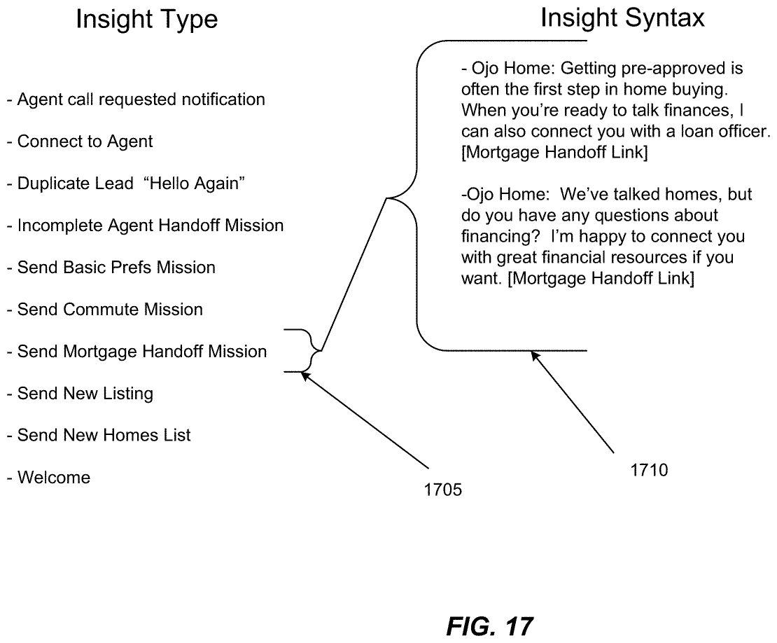

FIG. 17 shows the insight syntax selections 1710 available for the send mortgage handoff mission type 1705. In certain embodiments, the insight communication selected from insight syntax 1710 may include a link, shown here as “Mortgage Handoff Link”, which directs the user to resources that may be used to obtain mortgage financing. As an example, activation of the mortgage handoff link may direct the user to a financial institution, a mortgage broker, etc.

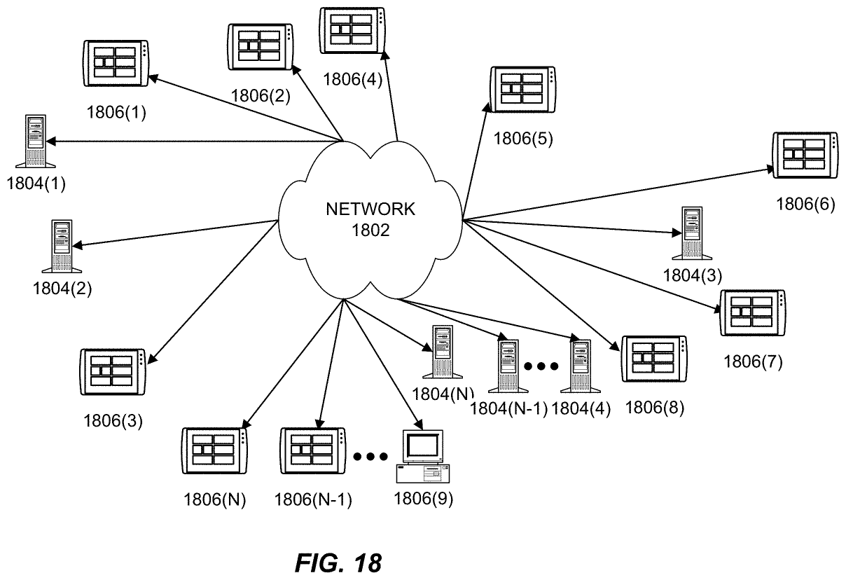

FIG. 18 is a block diagram illustrating an exemplary network environment in which the machine learning system that includes a learning, ranked response selection module response selection module may be practiced. Network 1802 (e.g. a private wide area network (WAN) or the Internet) includes a number of networked computer systems 1804(1)-(N) that can each implement a specialized machine learning system and the learning, ranked response selection module response selection module. Communication between user requestor devices 1806(1)-(N) and each specialized machine learning system and the learning, ranked response selection module response selection module 1804(1)-(N) typically occurs over a network, such as a public switched telephone network or cable network of asynchronous digital subscriber line (ADSL) channels or high-bandwidth trunks, for example communications channels providing T1 or OC3 service. Requestor devices 1806(1)-(N) typically access server computer systems 1804(1)-(N) through a service provider, such as an internet service provider (“ISP”) by executing application specific software, commonly referred to as a browser, on one of requestor devices 1306(1)-(N).

Requestor device 1806(1)-(N) and/or specialized machine learning systems and the learning, ranked response selection module response selection modules 1804(1)-(N) may include, for example, computer systems of any appropriate design, including a mainframe, a mini-computer, a personal computer system including notebook computers, a wireless, mobile computing device (including personal digital assistants, smart phones, and tablet computers). These computer systems are typically information handling systems, which are designed to provide computing power to one or more users, either locally or remotely. Such a computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the machine learning system and the learning, ranked response selection module response selection module can be implemented using code stored in a tangible, non-transient computer readable medium and executed by one or more processors. In at least one embodiment, the machine learning system and the learning, ranked response selection module response selection module can be implemented completely in hardware using, for example, logic circuits and other circuits including field programmable gate arrays.

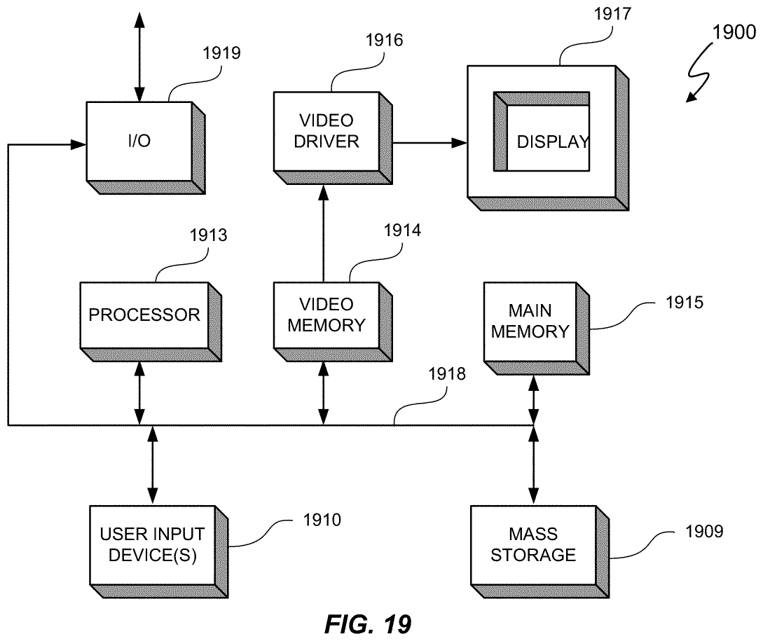

Embodiments of individual machine learning systems 1804(1)-(N) can be implemented on a computer system such as computer 1900 illustrated in FIG. 19. The computer 1900 can be a dedicated computer system or a virtual, emulated system located in, for example, a cloud computing environment. Input user device(s) 1910, such as a keyboard and/or mouse, are coupled to a bi-directional system bus 1918. The input user device(s) 1910 are for introducing user input to the computer system and communicating that user input to processor 1913. The computer system of FIG. 19 generally also includes a non-transitory video memory 1914, non-transitory main memory 1415, and non-transitory mass storage 1409, all coupled to bi-directional system bus 1918 along with input user device(s) 1910 and processor 1913. The mass storage 1909 may include both fixed and removable media, such as a hard drive, one or more CDs or DVDs, solid state memory including flash memory, and other available mass storage technology. Bus 1918 may contain, for example, 32 of 64 address lines for addressing video memory 1914 or main memory 1915. The system bus 1918 also includes, for example, an n-bit data bus for transferring DATA between and among the components, such as CPU 1409, main memory 1915, video memory 1914 and mass storage 1909, where “n” is, for example, 32 or 64. Alternatively, multiplex data/address lines may be used instead of separate data and address lines.

I/O device(s) 1919 may provide connections to peripheral devices, such as a printer, and may also provide a direct connection to remote server computer systems via a telephone link or to the Internet via an ISP. I/O device(s) 1919 may also include a network interface device to provide a direct connection to remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as instructions and data in a non-transient computer readable medium such as a flash memory, optical memory, magnetic memory, compact disks, digital versatile disks, and any other type of memory. The computer program is loaded from a memory, such as mass storage 1909, into main memory 1915 for execution. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 1913, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 1915 is comprised of dynamic random access memory (DRAM). Video memory 1914 is a dual-ported video random access memory. One port of the video memory 1914 is coupled to video amplifier 1916. The video amplifier 1916 is used to drive the display 1917. Video amplifier 1916 is well known in the art and may be implemented by any suitable means. This circuitry converts pixel DATA stored in video memory 1914 to a raster signal suitable for use by display 1917. Display 1917 is a type of monitor suitable for displaying graphic images. The computer system described above is for purposes of example only.

Although embodiments have been described in detail, it should be understood that various changes, substitutions, and alterations can be made hereto without departing from the spirit and scope of the invention as defined by the appended claims.

What is claimed is:

1. A method of machine learning in the selection of a ranked insight communication to a recipient device of a system user, the method comprising:
in an electronic, machine learning processing system:
initiating selection of a ranked insight communication in response to a triggering event;
responding to the triggering event by providing event data, wherein the event data includes user data that is specific to the system user;
deriving filter parameters from the event data;
querying a library of insight templates, wherein the insight templates are associated with respective insight template filtering criteria, wherein the querying identifies candidate insight templates having template filtering criteria met by the filter parameters;
receiving a selection of the insight templates that meet the insight template filtering criteria;
operating an insight ranking engine to rank the selection of candidate insight templates in accordance with insight ranking criteria;
selecting a ranked candidate insight template that is to be used to provide an insight communication to the recipient device based on ranking of the candidate insight templates;
deriving an insight communication that responds to the triggering event using the selected candidate insight template;
providing the insight communication to the recipient device; and
providing feedback to the insight ranking engine to refine the insight ranking criteria.

2. The method of claim 1, wherein the triggering event comprises one or more of:
a timed event associated with the system user;
initiation of a communication by the recipient device;
content of structured data input received from the recipient device.

3. The method of claim 1, wherein the insight templates are organized by insight template types, the method further comprising:
querying the library of insight templates to identify candidate insight template types that meet the response template filtering criteria to filter the insight response template types;
receiving a selection of candidate insight template types that meet the insight template filtering criteria;
operating an insight type ranking engine to rank the selection of candidate insight template types in accordance with insight type ranking criteria; and
selecting a highest ranked candidate insight template type pursuant to providing the insight communication to the device.

4. The method of claim 3, wherein at least one insight template type includes a plurality of insight communications having differing syntax, the method further comprising:
operating an insight communication ranking engine to rank the selection of the plurality of insight communications having different syntax; and
selecting the insight communication of the plurality of insight communications for communication to the recipient device.

5. The method of claim 3, wherein the insight template types include one or more of:
an agent call requested notification template type;
a connect to agent template type;
a duplicate lead template type;
a send basic preferences mission template type;
a send commute mission template type;
a send mortgage handoff mission template type;
a send new listing template type;
a send new homes list template type; and
a welcome message template type.

6. The method of claim 1, further comprising:
receiving structured data input from the recipient device, wherein the structured data input includes response filtering parameters for conversion into response template filtering criteria;
converting the response filtering parameters into the response template filtering criteria;
querying a library of response templates to identify candidate response templates that meet the response template filtering criteria to filter the response templates;
receiving a selection of the candidate response templates that meet the response template filtering criteria and respond to the structured input data;
operating a response ranking engine to rank the selection of candidate response templates in accordance with response ranking criteria;
selecting a highest ranked candidate response template to provide a response to the recipient device;
deriving the response to the structured data input from the selected, highest ranked, candidate response template;
providing the response to the recipient device; and
providing feedback to the response ranking engine to refine the response ranking criteria.

7. The method of claim 1, wherein the triggering event includes receipt of structured data input from the recipient device, wherein the structured data input includes the insight filtering parameter data and provides insight into the user to formulate the structured data input for converting the filter parameters into the insight template filtering criteria.

8. An apparatus for machine learning in the selection of a ranked insight communication to a recipient device associated with a system user, the apparatus comprising:
one or more data processors;
a memory, coupled to the data processors, having code stored therein to cause the one or more data processors to:
initiate selection of a ranked insight communication in response to a triggering event;
respond to the triggering event by providing event data, wherein the event data includes user data that is specific to the system user;
derive filter parameters from the event data;
query a library of insight templates, wherein the insight templates are associated with respective insight template filtering criteria, wherein the query identifies candidate insight templates having template filtering criteria met by the filter parameters;
receive a selection of the insight templates that meet the insight template filtering criteria;
operate an insight ranking engine to rank the selection of candidate insight templates in accordance with insight ranking criteria;
select a ranked candidate insight template that is to be used to provide an insight communication to the recipient device based on the ranking of the candidate insight templates;
derive an insight communication that responds to the triggering event using the selected candidate insight template;
provide the insight communication to the recipient device; and
provide feedback to the insight ranking engine to refine the insight ranking criteria.

9. The apparatus of claim 8, wherein the triggering event comprises one or more of:
a timed event associated with the system user;
initiation of a communication by the recipient device;
content of structured data input received from the recipient device.

10. The apparatus of claim 8, wherein the insight templates are organized by insight template types, the code further operating the apparatus to:
query the library of insight templates to identify candidate insight template types that meet the response template filtering criteria to filter the insight response template types;
receive a selection of candidate insight template types that meet the insight template filtering criteria;
operate an insight type ranking engine to rank the selection of candidate insight template types in accordance with insight type ranking criteria; and
select a highest ranked candidate insight template type pursuant to providing the insight communication to the device.

11. The apparatus of claim 10, wherein at least one insight template type includes a plurality of insight communications having differing syntax, the code further operating to:
operate an insight communication ranking engine to rank the selection of the plurality of insight communications having different syntax; and
select the insight communication of the plurality of insight communications for communication to the recipient device.

12. The apparatus of claim 10, wherein the insight template types include one or more of:
an agent call requested notification template type;
a connect to agent template type;
a duplicate lead template type;
a send basic preferences mission template type;
a send commute mission template type;
a send mortgage handoff mission template type;
a send new listing template type;
a send new homes list template type; and
a welcome message template type.

13. The apparatus of claim 8, wherein the code further operates to:
receive structured data input from the recipient device, wherein the structured data input includes response filtering parameters for conversion into response template filtering criteria;
convert the response filtering parameters into the response template filtering criteria;
query a library of response templates to identify candidate response templates that meet the response template filtering criteria to filter the response templates;
receive a selection of the candidate response templates that meet the response template filtering criteria and respond to the structured input data;
operate a response ranking engine to rank the selection of candidate response templates in accordance with response ranking criteria;
select a highest ranked candidate response template to provide a response to the recipient device;
derive the response to the structured data input from the selected, highest ranked, candidate response template;
provide the response to the recipient device; and
providing feedback to the response ranking engine to refine the response ranking criteria.

14. The apparatus of claim 9, wherein the triggering event includes receipt of structured data input from the recipient device, wherein the structured data input includes the insight filtering parameter data and provides insight into the user to formulate the structured data input for converting the filter parameters into the insight template filtering criteria.

15. A non-transitory, computer program product comprising code stored therein and executable by one or more processors to cause machine learning in the selection of a ranked insight communication to a recipient device associated with a system use, wherein the code is executable to cause the one or more processors to:
initiate selection of a ranked insight communication in response to a triggering event;
respond to the triggering event by providing event data, wherein the event data includes user data that is specific to the system user;
derive filter parameters from the event data;
query a library of insight templates, wherein the insight templates are associated with respective insight template filtering criteria, wherein the query identifies candidate insight templates having template filtering criteria met by the filter parameters;
receive a selection of the insight templates that meet the insight template filtering criteria;
operate an insight ranking engine to rank the selection of candidate insight templates in accordance with insight ranking criteria;
select a ranked candidate insight template that is to be used to provide an insight communication to the recipient device based on the ranking of the candidate insight templates;
derive an insight communication that responds to the triggering event using the selected candidate insight template;
provide the insight communication to the recipient device; and
provide feedback to the insight ranking engine to refine the insight ranking criteria.

16. The non-transitory, computer-readable storage medium of claim 15, wherein the triggering event comprises one or more of:
a timed event associated with the system user;
initiation of a communication by the recipient device;
content of structured data input received from the recipient device.

17. The non-transitory, computer-readable storage medium of claim 15, wherein the insight templates are organized by insight template types, the code further operating the apparatus to:
query the library of insight templates to identify candidate insight template types that meet the response template filtering criteria to filter the insight response template types;
receive a selection of candidate insight template types that meet the insight template filtering criteria;
operate an insight type ranking engine to rank the selection of candidate insight template types in accordance with insight type ranking criteria; and
select a highest ranked candidate insight template type pursuant to providing the insight communication to the device.

18. The non-transitory, computer-readable storage medium of claim 17, wherein at least one insight template type includes a plurality of insight communications having differing syntax, the code further operating to:
operate an insight communication ranking engine to rank the selection of the plurality of insight communications having different syntax; and
select the insight communication of the plurality of insight communications for communication to the recipient device.

19. The non-transitory, computer-readable storage medium of claim 17, wherein the insight template types include one or more of:
an agent call requested notification template type;
a connect to agent template type;
a duplicate lead template type;
a send basic preferences mission template type;
a send commute mission template type;
a send mortgage handoff mission template type;
a send new listing template type;
a send new homes list template type; and
a welcome message template type.

20. The non-transitory, computer-readable storage medium of claim 15, wherein the code is further executable to:
receive structured data input from the recipient device, wherein the structured data input includes response filtering parameters for conversion into response template filtering criteria;
convert the response filtering parameters into the response template filtering criteria;
query a library of response templates to identify candidate response templates that meet the response template filtering criteria to filter the response templates;
receive a selection of the candidate response templates that meet the response template filtering criteria and respond to the structured input data;
operate a response ranking engine to rank the selection of candidate response templates in accordance with response ranking criteria;
select a highest ranked candidate response template to provide a response to the recipient device;
derive the response to the structured data input from the selected, highest ranked, candidate response template;
provide the response to the recipient device; and
providing feedback to the response ranking engine to refine the response ranking criteria; and
wherein the triggering event includes receipt of structured data input from the recipient device, wherein the structured data input includes the insight filtering parameter data and provides insight into the user to formulate the structured data input for converting the filter parameters into the insight template filtering criteria.
